(19) United States
(12) Patent Application Publication
(10) Pub. No.: US 2006/0147663 A1
(43) Pub. Date: Jul. 6, 2006

(54) Co-extruded film structures of polypropylene impact copolymer with other polymers

(75) Inventors: Vincent Henri Barre, Seabrook, TX (US); Juan Jose Aguirre, League City, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/026,848

(22) Filed: Dec. 30, 2004

(51) Int. Cl. B32B 27/32

(52) U.S. Cl. 428/35.2; 428/172

(57) ABSTRACT

It has been discovered that the properties of sheet or film materials or structures can be improved by co-extruding a rubber-impact modified heterophasic copolymer core layer with at least a second polyolefin. The second polyolefin may be a Ziegler-Natta catalyzed polyethylene (ZN PE), Ziegler-Natta catalyzed polypropylene random copolymer (ZN PP RCP), a metallocene catalyzed polypropylene random copolymer (mPP RCP), a linear low density polyethylene (LLDPE) and/or a metallocene catalyzed medium density polyethylene (mMDPE). Improvements include, but are not necessarily limited to, reduced haze and increased gloss. These sheet or film materials may be co-extruded with other resins or laminated with other materials after extrusion.

### FIELD OF THE INVENTION

The invention is related to methods and compositions useful to improve the manufacture of sheets or blown films containing polypropylene. It relates more particularly to methods for making laminates of impact copolymers also known as heterophasic copolymers with other copolymers to improve the characteristics thereof, as well as the resulting film and sheet materials.

### BACKGROUND OF THE INVENTION

Among the different possible ways to convert polymers into films, the blown film process with air-cooling is probably the most economical and also the most widely used. This is because films obtained by blowing have a tubular shape which makes them particularly advantageous in the production of bags for a wide variety of uses (e.g. bags for urban refuse, bags used in the storage of industrial materials, for frozen foods, carrier bags, etc.) as the tubular structure enables the number of welding joints required for formation of the bag to be reduced when compared with the use of flat films, with consequent simplification of the process. Moreover, the versatility of the blown-film technique makes it possible, simply by varying the air-insufflation parameters, to obtain tubular films of various sizes, therefore avoiding having to trim the films down to the appropriate size as is necessary in the technique of extrusion through a flat head.

To date the application of polypropylene (PP) for blown film technology has been restricted to niche applications or technologies, such as PP blown film process with water contact cooling ring for highly transparent packaging film and PP used as sealing or temperature resistance layer in multilayer structures. Recently, blown film producers are showing more interest developing new structures with polypropylene. Polypropylene is expected to offer some advantages (e.g. heat resistance, puncture resistance, downgauge) compared to polyethylene. It has been seen that impact copolymers (or heterophasic copolymers) with low melt flow rate, such as ATOFINA® PP 4180 polypropylene and ATOFINA® 4170 polypropylene, have high melt strength and good mechanical properties that enable blown extrusion in monolayer structures with good bubble stability.

Some resin suppliers have patents relating to monolayer and multilayer structures made using impact copolymers. Several applications are mentioned including industrial bags, bags for frozen foods, carrier bags, heavy-duty shipping sacks, among others. There is a constant need for materials having improved properties for particular applications.

It would be desirable if methods could be devised or discovered to provide polypropylene film or sheet materials having improved properties.

### SUMMARY OF THE INVENTION

There is provided, in one form, a co-extruded film or sheet structure that involves a core layer containing at least one broad molecular weight distribution ethylene/propylene rubber impact-modified heterophasic copolymer (ICP). The co-extruded structure also involves at least one skin or intermediate layer on the core layer, where the skin layer contains a second polyolefin that may be a Ziegler-Natta catalyzed polyethylene (ZN PE), a Ziegler-Natta catalyzed polypropylene random copolymer (ZN PP RCP), a metallocene catalyzed polypropylene random copolymer (mPP RCP), a linear low density polyethylene (LLDPE), and/or a metallocene catalyzed medium density polyethylene (mMDPE).

In another embodiment, there is provided in another non-limiting form, a co-extruded film or sheet structure that involves a core layer containing at least one broad molecular weight distribution ethylene/propylene rubber impact-modified heterophasic copolymer (ICP). The core layer ranges in thickness between about 11 to about 150 microns. The co-extruded structure also involves at least one skin or intermediate layer comprising a second polyolefin that may be a ZN PE, a ZN PP RCP, a mPP RCP, a LLDPE, and/or a mMDPE. The skin layer ranges in thickness between about 3.5 to about 50 microns. The structure has reduced haze and increased gloss as compared with a core structure of total equal thickness absent the skin layer.

### BRIEF DESCRIPTION OF THE DRAWINGS

FIG. 1 is a plot of the puncture resistance of four inventive co-extruded film structures and one comparative structure;

FIG. 2 is a graph comparison of dart and tear resistance for five 2.0 ml (51 μ) film structures, four inventive co-extruded film structures and one comparative structure;

FIG. 3 is a graph comparison of the secant modulus for five 2.0 ml (51 μ) film structures, four inventive co-extruded film structures and one comparative structure;

FIG. 4 is a graph comparison of the tensile strength for five 2.0 ml (51 μ) film structures, four inventive co-extruded film structures and one comparative structure;

FIG. 5 is a graph comparison of the haze and gloss values for five 2.0 ml (51 μ) film structures, four inventive co-extruded film structures and one comparative structure;

FIG. 6 is a graph comparison of the permeability properties for five 2.0 ml (51 μ) film structures, four inventive co-extruded film structures and one comparative structure; and

FIG. 7 is a graph comparison of the 1-mil (25.4 μ) normalized permeability properties for the five 2.0 ml (51 μ) film structures of FIG. 6.

### DETAILED DESCRIPTION OF THE INVENTION

In some specific applications, such as bags where clarity is needed, it has been discovered that the use of polyethylene or polypropylene random copolymers associated to or adhered to impact copolymers in a multilayer structure may exhibit some mechanical and barrier property benefits.

It has further been discovered that broad molecular weight distribution ethylene/propylene rubber impact-modified heterophasic copolymers (ICPs) such as ATOFINA's 4180 polypropylene may be advantageously co-extruded with other polyolefins to give blown films and sheet material structures having improved properties. The ICP copolymers may be co-extruded with second polyolefins such as Ziegler-Natta catalyzed polyethylene (ZN PE), Ziegler-Natta catalyzed polypropylene random copolymer (ZN PP RCP), and/or metallocene catalyzed polypropylene random copolymer (mPP RCP). These studies will help to develop expertise in blown film that will support polyethylene and polypropylene businesses and result in novel blends and film and sheet materials. It has been surprisingly found that polypropylene works synergistically in giving some structures with better optical characteristics, but that still retain dart drop and tear resistance characteristics of single layer ICP films.

The broad molecular weight distribution ethylene/propylene rubber impact-modified heterophasic copolymer (ICP) that is the primary or only polymer used in the core layer may be one having a polydispersity from about 4 to about 12, a melt flow rate from about 0.5 to about 5.0 dg/min, and xylene solubles of 25% or less. Impact copolymers falling within this definition include, but are not necessarily limited to ATOFINA's 4180, 4170, and 4280W polypropylene. In one non-limiting embodiment, the ICP may have a polydispersity from about 5 to about 10, a melt flow rate from about 0.5 to about 2.5 dg/min, and xylene solubles of 25% or less. In an alternate non-limiting embodiment, the xylene solubles may range from about 10 to 25 wt %, and in another alternative from about 15 to 25 wt %. In another non-limiting embodiment, the impact copolymer may have a melting point ranging from about 155 to about 170° C. and a 1% secant modulus of from about 100 to about 225 kpsi. In an alternate non-limiting embodiment, the impact copolymer may have a melting point ranging from about 158 to about 166° C. and a 1% secant modulus of from about 100 to about 175 kpsi. The density of the impact copolymer may range from about 0.89 to about 0.92 gr/cm³ in one non-limiting embodiment, and from about 0.9 to 0.91 gr/cm³ in an alternate embodiment. And in still another non-limiting embodiment the ethylene content of the impact copolymer may range from about 7 to about 15 wt %, and alternatively from about 9 to about 14 wt %. Methods for making ICPs are well known in the art, for instance, in one non-limiting embodiment methods and techniques as described in U.S. Pat. No. 6,657,024, incorporated herein by reference, may be used.

The impact copolymer may be co-extruded with a second polyolefin that forms at least one skin layer or intermediate layer on the impact copolymer which forms the core layer. In one non-limiting embodiment, there is a skin layer on both, opposing sides of the core layer. The skin layers may be symmetrical, that is, have essentially the same thickness and composition. In another non-restrictive embodiment, in the case where at least one skin layer is on either side of the core layer, the skin layers may be asymmetrical, i.e., have different thicknesses and compositions. In an alternate, non-limiting embodiment, there may be more than one skin layer on one or the other side of the core layer.

One suitable, second polyolefin useful for coextruding with ICP are random copolymers (RCPs) of propylene and a comonomer selected from the group consisting of ethylene, butenes, and larger α-olefins that are polymerized with propylene using Ziegler-Natta or metallocene catalysts. As defined herein the larger α-olefins may have from 5 to 18 carbon atoms. The Ziegler-Natta catalysts may typically be conventional Ziegler-Natta catalysts of the type disclosed, for example, in U.S. Pat. Nos. 4,298,718 and 4,544,717, both to Mayr, et al., as non-limiting examples, both incorporated by reference herein in their entirety. The so-called conventional Ziegler-Natta catalysts are stereospecific complexes formed from a transition metal halide and a metal alkyl or hydride.

Catalysts employed in the polymerization of a-olefins may be characterized as supported catalysts or unsupported catalysts, sometimes referred to as homogeneous catalysts. Traditional supported catalysts are the so-called “standard” Ziegler-Natta catalysts, such as titanium tetrachloride supported on an active magnesium dichloride. A supported catalyst component includes, but is not necessarily limited to, titanium tetrachloride supported on an “active” anhydrous magnesium dihalide, such as magnesium dichloride or magnesium dibromide. A supported catalyst component may be employed in conjunction with a co-catalyst such as an alkylaluminum compound, for example, triethylaluminum (TEAL). The Ziegler-Natta catalysts may also incorporate an electron donor compound that may take the form of various amines, phosphenes, esters, aldehydes, and alcohols.

Metallocene catalysts are coordination compounds or cyclopentadienyl groups coordinated with transitional metals through π-bonding. Metallocene catalysts are often employed as unsupported or homogeneous catalysts, although they also may be employed in supported catalyst components. With respect to the metallocene random copolymers, this term denotes polymers obtained by copolymerizing ethylene and an α-olefin, such as propylene, butene, hexene or octene, in the presence of a monosite catalyst generally consisting of an atom of a metal which may, for example, be zirconium or titanium, and of two cyclic alkyl molecules bonded to the metal. More specifically, the metallocene catalysts are usually composed of two cyclopentadiene-type rings bonded to the metal. These catalysts are often used with aluminoxanes as cocatalysts or activators, in one non-limiting embodiment methylaluminoxane (MAO). Hafnium may also be used as a metal to which the cyclopentadiene is bound. Other metallocenes may include transition metals of groups IV A, V A and VI A. Metals of the lanthanide series may also be used.

These metallocene RCPs may also be characterized by their M_{w}/Mₙ ratio (polydispersity) of <4, alternatively <3.5, otherwise <3, in various non-limiting embodiments. Furthermore, the M_{z}/M_{w} ratio is <2.3, alternatively <2.15, and otherwise <2.0. In one non-limiting embodiment, the mRCP used in the film structures herein has a melt flow rate of from about 0.5 to about 100 dg/min, a melting point of about 105° C. to about 158° C. and a secant modulus from about 10 kpsi to about 150 kpsi. In another non-limiting embodiment, the mPP RCP may have a melt flow rate of from about 8 to about 20 dg/min, a melting point of about 105° C. to about 120° C. and a secant modulus from about 30 kpsi to about 65 kpsi. Furthermore, the density of the mRCP may range from about 0.88 to about 0.92 gr/cm³ in one non-limiting embodiment, and alternatively from about 0.89 to about 0.90 gr/cm³. Additionally, the xylene solubles in one non-limiting embodiment may be less than about 5 wt %, and alternatively less than about 2 wt %. Further, the ethylene content may range from trace amounts to about 8 wt % in one non-limiting embodiment, and alternatively from trace amounts to about 5 wt %.

The Ziegler-Natta RCPs may also be characterized by their M_{w}/Mₙ ratio (polydispersity) of from about 5.0 to about 10.0, alternatively from about 5.5 to about 8.5, in various non-limiting embodiments. Furthermore, the M_{z}/M_{w} ratio may range from about 2.5 to about 5.5, and alternatively from about 3.0 to about 5.0. In one non-limiting embodiment, the ZN PP RCP used in the co-extruded sheet structures herein has a melt flow rate of from about 0.5 to about 100 dg/min, a melting point of about 105° C. to about 158° C. and a secant modulus from about 10 kpsi to about 150 kpsi. In another non-limiting embodiment, the ZN PP RCP may have a melt flow rate of from about 0.5 to about 30 dg/min, a melting point of about 110° C. to about 135° C. and a secant modulus from about 30 kpsi to about 60 kpsi. Furthermore, the density of the ZN PP RCP may range from about 0.88 to about 0.92 gr/cm³ in one non-limiting embodiment, and alternatively from about 0.89 to about 0.90 gr/cm³. Additionally, the xylene solubles in one non-limiting embodiment may be less than about 14 wt %, and alternatively less than about 12 wt %. Further, the ethylene content may range from trace amounts to about 12 wt % in one non-limiting embodiment, and alternatively from trace amounts to about 8 wt %.

In the case where the second polyolefin ZN PE is medium density polyethylene, the polyethylene is made using catalysts already described and techniques already described or well known in the art. In one non-limiting embodiment, the MDPE suitable herein has a melt index (MI₂) of from about 0.1 dg/min to about 5 dg/min and a density of about 0.925 to about 0.939 gr/cm³. In another non-limiting embodiment, the MDPE has a melt index (MI₂) of from about 0.23 to about 0.33 dg/min and a density of about 0.930 to about 0.937 gr/cm³. The melting point of the MDPE may range from about 118 to about 135° C. in one non-limiting embodiment, and alternatively from about 120 to about 130° C. The 1% secant modulus of MDPE may range from about 30 to about 80 kpsi and alternatively from about 40 to about 70 kpsi in non-limiting embodiments. The polydispersity of the MDPE suitable may range from about 9 to about 17 in one non-limiting embodiment, and alternatively from about 11 to about 15. The M_{z}/M_{w} ratio for MDPE may range from about 10 to about 16, and alternatively from about 8 to about 14 in non-limiting embodiments. One non-limiting embodiment of a ZN MDPE is FINATHENE® HL 328 MDPE available from ATOFINA® Petrochemicals Inc., but of course is not limited to this material. In one non-limiting embodiment, it is not expected that MDPE will improve the clarity of the co-extruded films or sheet structures.

With respect to the non-limiting embodiment where the second polyolefin ZN PE in the skin layer is medium molecular weight (MMW) high density polyethylene (HDPE), the polyethylene is also made using catalysts already described and techniques already described or well known in the art. By “medium molecular weight is meant a molecular weight ranging from about 100,000 Mw to about 200,000 Mw, and alternatively in another non-limiting embodiment ranging from about 65,000 Mw to about 240,000 Mw. The melt flow index (MFI) at 190° C., 2.16 kg may range from about 0.5 to about 8 g/10 min, and alternatively from about 0.6 to about 5.0 g/10 min. In another non-limiting embodiment, the HDPE has a melt index (MI₂) of from about 0.8 to about 3 dg/min and a density of about 0.940 to about 0.970 gr/cm³, and alternatively from about 0.945 to about 0.965 gr/cm³. The melting point of the HDPE may range from about 125 to about 145° C. in one non-limiting embodiment, and alternatively from about 130 to about 140° C. The 1% secant modulus of HDPE may range from about 110 to about 140 kpsi and alternatively from about 115 to about 135 kpsi in non-limiting embodiments. The polydispersity of the HDPE may range from about 3 to about 6 in one non-limiting embodiment, and alternatively from about 3.5 to about 5. Suitable ZN HDPEs include, but are not necessarily limited to, FINATHENE® 6410 HDPE, FINATHENE® 6420 and FINATHENE® 6450 available from ATOFINA® Petrochemicals Inc. A proprietary catalyst system is used to manufacture MMW-HDPE film grades with exceptional properties including, but not necessarily limited to, low haze, high gloss, extremely low gel content and low taste and odor.

In another non-restrictive embodiment the second polyolefin of the skin layer may be a linear low density polyethylene (LLDPE). Suitable LLDPEs may be made using catalysts already described and/or well known in the art. In one non-limiting embodiment, the LLDPE has a melt index of from about 0.5 to about 1.5 g/10 min., and in another non-restrictive embodiment from about 0.75 to about 1.25 g/10 min. Appropriate LLDPE may have a density of from about 0.903 to about 0.933 g/cm³ and in another non-restrictive embodiment from about 0.913 to about 0.923 g/cm³. Suitable LLDPE may have a melting point of from about 110 to about 130° C. in one non-restrictive embodiment, and from about 116 to about 126° C. in another non-limiting embodiment. A suitable LLDPE includes, but is not necessarily limited to ExxonMobil Chemical LL-1001 butene/ethylene copolymer LLDPE blown film resin.

In yet another non-restrictive embodiment the second polyolefin used in the skin layer may be a metallocene-catalyzed medium density polyethylene (mMDPE) that has a melt index (MI₂) of from about 0.25 to about 9.0 dg/min, a density of about 0.915 to about 0.949 gr/cm³, a melting point of about 115 to about 125° C., and polydispersity Mw/Mn of less than 4.0. Metallocene-based resins falling within this definition include, but are not necessarily limited to ATOFINA's M 3410 EP, ER 2277, ER 2281, ER 2278 and ER 2279 medium density polyethylene resins. In one non-limiting embodiment the mMDPE may be one having a melt index (MI₂) of from about 0.20 to about 20.0 dg/min, a density of about 0.85 to about 0.95 gr/cm³, a melting point of about 100° C. to about 145° C.

Blends of polymers may be employed for the core layer and/or the skin layers of the film structures, and the blends may be prepared using technologies known in the art, such as the mechanical mixing of the polyolefins using high-shear internal mixers of the Banbury type, or by mixing directly in the extruder. Suitable extruders include, but are not limited to, single screw, co-rotating twin-screws, contra-rotating twin-screws, BUSS extruders, and the like. Although special blending equipment and techniques are acceptable, in one non-limiting embodiment the blends are made using the conventional extruders associated with blown film production lines.

The polymers and blends of polymers may also contain various additives capable of imparting specific properties to the articles the blends are intended to produce. Additives known to those skilled in the art that may be used in these blends include, but are not necessarily limited to, fillers such as talc and calcium carbonate, pigments, antioxidants, stabilizers, anti-corrosion agents, slip agents, UV stabilizing agents and antiblock agents, etc.

In further processing the polymers are co-extruded with other resins to form multilayer films. The co-extrusion may be conducted according to methods well known in the art. Co-extrusion may be carried out by simultaneously pushing the polymer of the skin layer and the polymer of the core layer through a slotted or spiral die system to form a film formed of an outer layer of the skin polymer and substrate layer of the core polymer. As mentioned, additional layers may also be coextruded, either as an additional skin layer on the other surface of the substrate core layer, or layers serving other functions, such as barriers, anti-block layers, heat-sealing layers etc. Alternatively, a skin layer may be extrusion coated later in the film making process. In one non-limiting embodiment the skin layer may be relatively thick, and the skin layer smoothes the surface of the impact copolymer core. Also, other layers may be added to create a more complex film after or contemporaneous with the formation of the basic film or sheet structure. In one non-limiting embodiment the co-extruded film or sheet structure have a core layer ranging in thickness between about 11 to about 150 microns, and the skin layer ranges in thickness between about 3.5 to about 50 microns. Furthermore, the film or sheet materials may be laminated with other materials after extrusion as well. Again, known techniques in laminating sheets and films may be applied to form these laminates.

Articles that may be wrapped with these co-extruded films or sheet structures include, but are not necessarily limited to, frozen foods, other foods, urban refuse, fresh cut produce, detergent bags, towel overwrap, and the like.

The methods, films and structures discussed herein will now be described further with respect to actual Examples that are intended simply to further illustrate the concept and not to limit it in any way.

### EXAMPLES 1-5

Table I displays the materials and the structures used in this studies. Polymer abbreviations are given in the Glossary. These films would be suitable for use in food packaging, specialty bags, and the like.

TABLE I
Materials and Structures Used in Examples 1-5

| Example | Inv. 1 | Inv. 2 | Inv. 3 | Inv. 4 | Comp. 5 |
|---|---|---|---|---|---|
| Skin layer A (microns) | 6410/1% AMF | HL 328 | HL 328 | 8473 | 4180 |
| | 705 HF (7.5) | (7.5) | (3.75) | (7.5) | (12.5) |
| Core layer B (microns) | 4180 (35) | 4180 (35) | 4180 (17.5) | 4180 (35) | 4180 (25) |
| Skin layer C (microns) | 6410/1% AMF | HL 328 | HL 328 | 8473 | 4180 |
| | 705 HF (7.5) | (7.5) | (3.75) | (7.5) | (12.5) |
| Total target thickness, | 2 (50) | 2 (50) | 1 (25) | 2 (50) | 2 (50) |
| mil (microns) | | | | | |

Each co-extruded film or sheet structure was produced on a Kiefel multi-layer blown film line according to the conditions in Table II:

TABLE II
Processing Conditions Used in Examples 1-5

| Variable | Unit | Value |
|---|---|---|
| Width | mm | 600 |
| Blow Up Ratio (BUR) for all structures | | 2.54 |
| Die diameter | mm | 150 |
| Barrel temperature | ° C. | 25-30 |
| Temp. profile for Extruders 1 & 3 | ° C. | 210-210 (PE) |
| | | 220-230 (PP) |
| Temp. profile for Extruder 2 | ° C. | 200-200 (PE/PP coex) |
| | | 220/230 (PP/PP coex) |
| Cooling system | | Dual lip |
| Cooling air temp. | ° C. | 20 |

Mechanical Properties of the Resulting Films

Puncture, Dart and Tear Properties

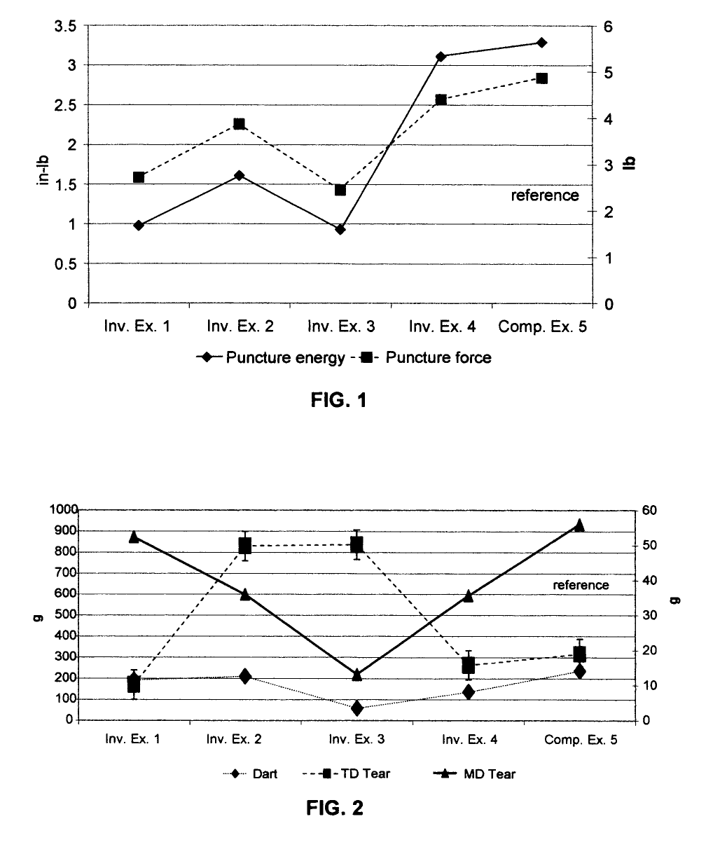

The 2-mil film puncture resistance data are displayed in FIG. 1. The pure impact copolymer polypropylene structures (comparative Example 5) have the best puncture resistance. When the outer layers are replaced by polyethylene, the puncture resistance decreases (Examples 14). Several previous studies by one of the co-inventors on the impact behavior of structures with fragile/ductile layers laminated on top of each other (fragile layer on the impact side) showed that when the fragile layer reaches its maximum deformation, it fractures and due to the bonding force between the layers the fracture travels through the ductile layer without a lot of energy absorption. The same type of phenomenon appears to be observed in the data of FIG. 1: the puncture resistance of the film appears to be mainly influenced by the puncture resistance of the outer layer.

FIG. 2 displays the dart and tear properties of the 2-mil films. The dart results of the structures of Examples 1 and 2 are similar to that of the reference Example 5. Replacing the polypropylene outer layer by a polyethylene did not significantly affect the dart of the materials. The structure of Example 3 has lower dart because of reduced thickness. This observation agrees with the puncture resistance results. The tear ratio varies considerably when HL 328 is used, but the tear ratio of the structure using 6410 is similar to that of the reference material of Example 5.

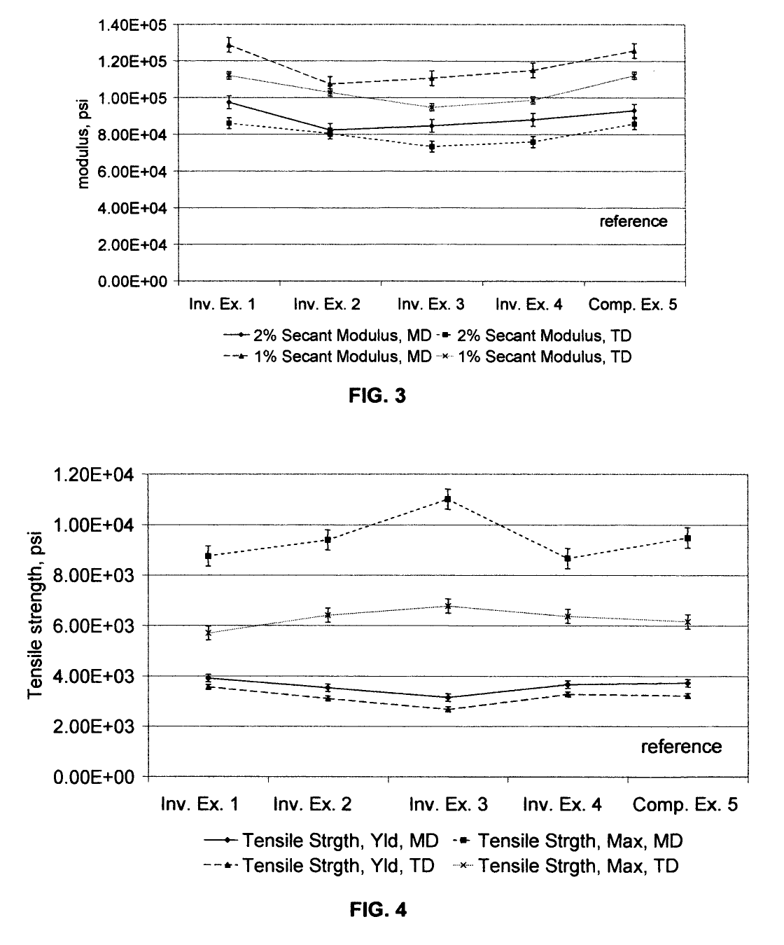

FIG. 3 displays the secant modulus of the two-mil films herein. The secant modulus of the multi-layers with HL 328 and 8473 in the outer layers are less stiff than the reference of Example 5. The structure using 6410 however exhibits comparable stiffness to the reference material.

FIG. 4 displays the tensile strength of the two-mil films. All the strengths are equivalent except for the structure of Example 3 (1-mil film), which has a little lower yield strength and a little higher max strength.

From-the data available in FIGS. 4 and 5, it appears that the tensile properties of the multilayer structure with 25-50-24% or 15-70-15% repartition are mainly driven by the polypropylene core layer. Changing the outer layer from polypropylene to polyethylene did not affect the strength significantly, but slightly reduced the modulus.

Other Properties of the Films

FIG. 5 shows the haze and the gloss of the inventive 2-mil films and comparative Example 5. While replacing the 4180 outer layers by HL 328 did not significantly improve the optical properties, the structures of Examples 1 and 4 using, respectively, 6410 and 8473 as outer layers did significantly improve the haze and the gloss of the final film. The polypropylene random copolymer outer layer slightly outperformed the unimodal polyethylene outer layer for optical properties. One non-limiting explanation is that most of the film haze comes from the surface and not the bulk part of the film. The “bulk haze” may contribute as little as 3% of the total haze for a single layer film. When 4180 ICP material is encapsulated between two layers of 6410 or 8473, the surface of the resulting film is made out of clear material. The interface between the skin layer and the core layer is smooth because the contact between the two polymers was made in a molten state. These observations explain the sharp decrease in haze when 6410 or 8473 are used as skin layer.

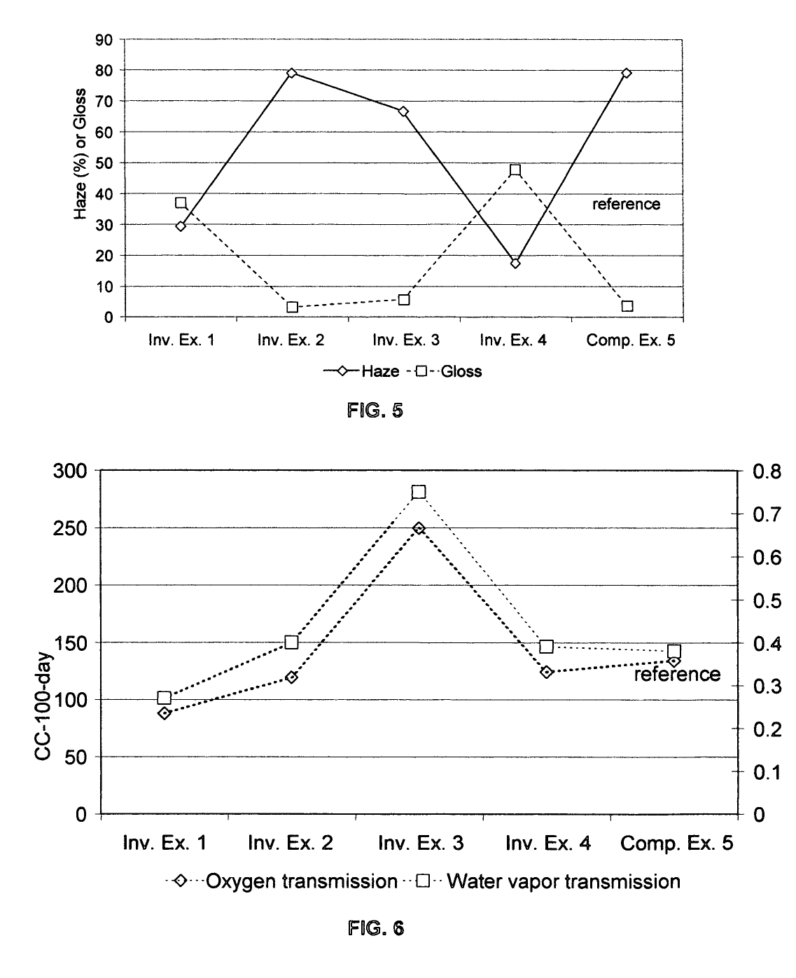

FIG. 6 shows the permeability properties of the 2-mil films. The spike in permeability of the Example 3 film structure is due to a reduced thickness (1-mil). The barrier properties of 6410 helped the film structure of Example 1 achieve reduced transmission rate.

Fick's First Law of Diffusion the permeability of a film is provided in Equation 1:

$$Pt = \frac{2303 W}{2 A} {log}_{10} [ \frac{{C}_{0}}{{C}_{0} - 2 {C}_{1}} ] \qquad Equation 1$$

where: P=permeability coefficient; I=film thickness; V=Volume of chamber of permeability cell (i.e., the experiment was performed with the film separating two chambers, of equal volume, of a cell: the permeant diffusing through the film from one chamber to the other from high concentration to low concentration); A=area of film exposed to permeant; t=time; C₀=initial permeant concentration; Cₜ=permeant concentration at time t. (The units of permeability are m²hr⁻¹.)

The permeability of a two-layer film is provided in Equation 2:

$$\frac{1}{total permeability} = \frac{thickness of A}{total thickness \times permeability of A} + \frac{thickness of B}{total thickness \times permeability of B}$$

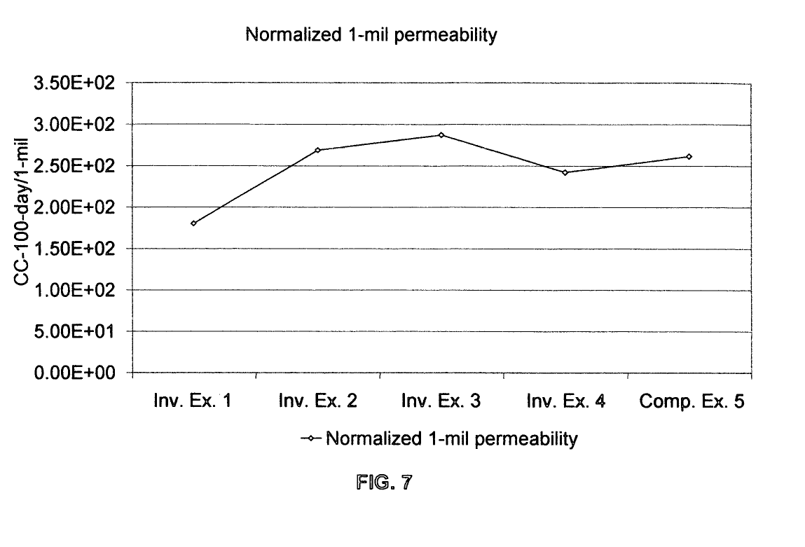

Equation 2 shows that when the relative thickness of the layer composing the film remains constant, (thickness of A/total thickness=cst), the total permeability coefficient remains the same regardless of the thickness. Therefore the permeability of the 2-mil films may be normalized as per Equation 1, the results of which are displayed in FIG. 7.

Among the 2-mil films created for specialty bag markets, the three layer 6410/4180/6410 presents better optical characteristics, reduced permeability and yet retains dart and tear resistance compared to a single-layer 4180 film. The puncture resistance of the 3-layer film is lower than that of the reference structure of Example 5.

The film structures of Examples 1 and 4 using 6410 and 8473, respectively, as outer layers did improve significantly the haze and the gloss of the final film.

In the foregoing specification, the films, sheet structures and methods have been described with reference to specific embodiments thereof, and has been demonstrated as effective in providing methods for preparing blown films having improved properties. However, it will be evident that various modifications and changes may be made thereto without departing from the scope of the invention as set forth in the appended claims. Accordingly, the specification is to be regarded in an illustrative rather than a restrictive sense. For example, specific combinations or proportions of polymers and other components falling within the claimed parameters, but not specifically identified or tried in a particular polymer laminate structure, are anticipated and expected to be within the scope of this invention. Further, these methods are expected to work at other conditions, particularly extrusion and blowing conditions, than those exemplified herein.

TABLE V
ASTM Film Test Methods Used

| Property | ASTM Procedure |
|---|---|
| Tensile Strength, Elongation, | D882 |
| Secant Modulus | |
| Haze | D1003 |
| Gloss | D2457 |
| Melt Flow Rate | D1238 - 230° C./2.16 kg |
| Melting Point | D3418 |
| Melt Flow Index | D1238 - 190° C./2.16 kg |
| Melt Index (MI₂) | D1238 - 190° C./2.16 kg |

### GLOSSARY

4180 ATOFINA® PP 4180 polypropylene; a fractional melt flow impact copolymer (ICP) produced with a Ziegler-Natta catalyst, available from Atofina Petrochemicals Inc.

6410 FINATHENE® 6410 high density polyethylene, available from Atofina Petrochemicals Inc.

6450 FINATHENE® 6450 high density polyethylene similar to but with a higher melt index than FINATHENE® 6410 HDPE, available from Atofina Petrochemicals Inc.

8473 ATOFINA® 8473 Ziegler-Natta Random Copolymer Heat Sealable Film Grade available from Atofina Petrochemicals Inc.

8573 ATOFINA® 8573 ZN RCP Heat Sealable Film Grade similar to ATOFINA® 8473 ZN RCP but with a higher melt flow, available from Atofina Petrochemicals Inc.

AMF 705 HF Antimelt fracture agent, material type 705 HF.

HL 328 FINATHENE® HL 328 MDPE; a medium density polyethylene produced with a chrome-type catalyst whose melt index is ˜0.28, and density 0.937 gr/cm³, available from Atofina Petrochemicals Inc.

What is claimed is:

1. A co-extruded film or sheet structure comprising:
a core layer comprising at least one broad molecular weight distribution ethylene/propylene rubber impact-modified heterophasic copolymer (ICP), and
at least one skin or intermediate layer comprising a second polyolefin selected from the group consisting of
a Ziegler-Natta catalyzed polyethylene (ZN PE),
a Ziegler-Natta catalyzed polypropylene random copolymer (ZN PP RCP),
a metallocene catalyzed polypropylene random copolymer (mPP RCP),
a linear low density polyethylene (LLDPE), and
a metallocene catalyzed medium density polyethylene (mMDPE), and mixtures thereof.

2. The co-extruded film or sheet structure of claim 1 where the ICP has a polydispersity from about 4 to about 12, a melt flow rate from about 0.5 to about 5.0 dg/min, and xylene solubles of about 25% or less.

3. The co-extruded film or sheet structure of claim 1 where the skin layer comprises one of the RCPs, and the RCP has a melt flow rate of from about 0.5 to about 100 dg/min, a melting point of about 105 to about 158° C. and a secant modulus from about 10 to about 150 kpsi.

4. The co-extruded film or sheet structure of claim 1 where the skin layer is a ZN PE, and where the polyethylene is a medium density polyethylene having a melt index (MI₂) of from about 0.1 to about 5.0 dg/min and a density of about 0.925 to about 0.939 gr/cm³.

5. The co-extruded film or sheet structure of claim 1 where the skin layer is a ZN PE, and where the polyethylene is a medium molecular weight high density polyethylene having a melt index (MI₂) ranging from about 0.8 to about 3.0, and a density of about 0.940 to about 0.970 gr/cm³.

6. The co-extruded film or sheet structure of claim 1 where the skin layer is a LLDPE having a melt index of from about 0.5 to about 1.5 g/10 min., a density of from about 0.903 to about 0.933 g/cm³, and a melting point of from about 110 to about 130° C.

7. The co-extruded film or sheet structure of claim 1 where the skin layer is a mMDPE having a melt index (MI₂) of from about 0.25 to about 9.0 dg/min, a density of about 0.915 to about 0.949 gr/cm³, a melting point of about 115 to about 125° C., and polydispersity Mw/Mn of less than 4.0.

8. The co-extruded film or sheet structure of claim 1 where the core layer ranges in thickness between about 11 to about 150 microns, and where the skin layer ranges in thickness between about 3.5 to about 50 microns.

9. The co-extruded film or sheet structure of claim 1 where the skin layer is a first skin layer and the co-extruded film or sheet structure further comprises at least a second skin layer on another side of the core layer, where the skin layers are the same thickness and comprise the same polyolefin.

10. The co-extruded film or sheet structure of claim 1 where the structure has reduced haze and increased gloss as compared with a core structure of total equal thickness absent the skin layer.

11. The co-extruded film or sheet structure of claim 10 where the structure has comparable dart drop strength and tear resistance compared with a core structure of total equal thickness absent the skin layer.

12. An article wrapped in the co-extruded film or sheet structure of claim 1.

13. A co-extruded film or sheet structure comprising:
a core layer consisting essentially of at least one broad molecular weight distribution ethylene/propylene rubber impact-modified heterophasic copolymer (ICP), and
at least one skin or intermediate layer consisting essentially of a second polyolefin is selected from the group consisting of
a Ziegler-Natta catalyzed polyethylene (ZN PE),
a Ziegler-Natta catalyzed polypropylene random copolymer (ZN PP RCP),
a metallocene catalyzed polypropylene random copolymer (mPP RCP),
a linear low density polyethylene (LLDPE), and
a metallocene catalyzed medium density polyethylene (mMDPE), and mixtures thereof.

14. The co-extruded film or sheet structure of claim 13 where the ICP has a polydispersity from about 4 to about 12, a melt flow rate from about 0.5 to about 5.0 dg/min, and xylene solubles of about 25% or less.

15. The co-extruded film or sheet structure of claim 13 where the skin layer comprises one of the RCPs, and the RCP has a melt flow rate of from about 0.5 to about 100 dg/min, a melting point of about 105 to about 158° C. and a secant modulus from about 10 to about 150 kpsi.

16. The co-extruded film or sheet structure of claim 13 where the skin layer is a ZN PE, and where the polyethylene is a medium density polyethylene having a melt index (MI₂) of from about 0.1 to about 5.0 dg/min and a density of about 0.925 to about 0.939 gr/cm³.

17. The co-extruded film or sheet structure of claim 13 where the skin layer is a ZN PE, and where the polyethylene is a medium molecular weight high density polyethylene having a melt index (MI₂) ranging from about 0.8 to about 3.0, and a density of about 0.940 to about 0.970 gr/cm³.

18. The co-extruded film or sheet structure of claim 13 where the skin layer is a LLDPE having a melt index of from about 0.5 to about 1.5 g/10 min., a density of from about 0.903 to about 0.933 g/cm³, and a melting point of from about 110 to about 130° C.

19. The co-extruded film or sheet structure of claim 13 where the skin layer is a mMDPE having a melt index (MI₂) of from about 0.25 to about 9.0 dg/min, a density of about 0.915 to about 0.949 gr/cm³, a melting point of about 115 to about 125° C., and polydispersity Mw/Mn of less than 4.0.

20. The co-extruded film or sheet structure of claim 13 where the core layer ranges in thickness between about 11 to about 150 microns, and where the skin layer ranges in thickness between about 3.5 to about 50 microns.

21. The co-extruded film or sheet structure of claim 13 where the skin layer is a first skin layer and the co-extruded film or sheet structure further comprises at least a second skin layer on another side of the core layer, where the skin layers are the same thickness and comprise the same polyolefin.

22. The co-extruded film or sheet structure of claim 13 where the structure has reduced haze and increased gloss as compared with a core structure of total equal thickness absent the skin layer.

23. The co-extruded film or sheet structure of claim 22 where the structure has comparable dart drop strength and tear resistance compared with a core structure of total equal thickness absent the skin layer.

24. An article wrapped in the co-extruded film or sheet structure of claim 13.

25. A co-extruded film or sheet structure comprising:
a core layer comprising at least one broad molecular weight distribution ethylene/propylene rubber impact-modified heterophasic copolymer (ICP), where the core layer ranges in thickness between about 11 to about 150 microns, and
at least one skin or intermediate layer comprising a second polyolefin is selected from the group consisting of
a Ziegler-Natta catalyzed polyethylene (ZN PE),
a Ziegler-Natta catalyzed polypropylene random copolymer (ZN PP RCP),
a metallocene catalyzed polypropylene random copolymer (mPP RCP);
a linear low density polyethylene (LLDPE), and
a metallocene catalyzed medium density polyethylene (mMDPE), and mixtures thereof; and
where the skin layer ranges in thickness between about 3.5 to about 35 microns;
where the structure has reduced haze and increased gloss as compared with a core structure of total equal thickness absent the skin layer.

26. The co-extruded film or sheet structure of claim 25 where the structure has comparable dart drop strength and tear resistance compared with a core structure of total equal thickness absent the skin layer.

27. The co-extruded film or sheet structure of claim 25 where the ICP has a polydispersity from about 4 to about 12, a melt flow rate from about 0.5 to about 5.0 dg/min, and xylene solubles of about 25% or less.

28. The co-extruded film or sheet structure of claim 25 where the skin layer comprises one of the RCPs, and the RCP has a melt flow rate of from about 0.5 to about 100 dg/min, a melting point of about 105 to about 158° C. and a secant modulus from about 10 to about 150 kpsi.

29. The co-extruded film or sheet structure of claim 25 where the skin layer is a ZN PE, and where the polyethylene is a medium density polyethylene having a melt index (MI₂) of from about 0.1 to about 5.0 dg/min and a density of about 0.925 to about 0.939 gr/cm³.

30. The co-extruded film or sheet structure of claim 25 where the skin layer is a ZN PE, and where the polyethylene is a medium molecular weight high density polyethylene having a melt index (MI₂) ranging from about 0.8 to about 3.0, and a density of about 0.940 to about 0.970 gr/cm³.

31. The coextruded film or sheet structure of claim 25 where the skin layer is a LLDPE having a melt index of from about 0.5 to about 1.5 g/10 min., a density of from about 0.903 to about 0.933 g/cm³, and a melting point of from about 110 to about 130° C.

32. The co-extruded film or sheet structure of claim 25 where the skin layer is a first skin layer and the co-extruded film or sheet structure further comprises at least a second skin layer on another side of the core layer, where the skin layers are the same thickness and comprise the same polyolefin.

33. An article wrapped in the co-extruded film or sheet structure of claim 25.
